(19) United States
(12) Patent Application Publication
(10) Pub. No.: US 2006/0115293 A1
(43) Pub. Date: Jun. 1, 2006

(54) Image forming apparatus

(75) Inventors: Young-wok Seo, Suwon-si (KR); In-sik Seo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/290,444

(22) Filed: Dec. 1, 2005

(30) Foreign Application Priority Data
Dec. 1, 2004 (KR) 10-2004-0099769

(51) Int. Cl. G03G 21/18

(52) U.S. Cl. 399/110; 399/111

(57) ABSTRACT

In an image forming apparatus, a module box moves between a first position and a second position. A locking/unlocking unit locks the module box into the first position, and a biasing unit biases the module box from the first position to the second position when the locking/unlocking unit is unlocked. Object components (such as developer cartridges, or intermediate transfer belt assemblys) are detachably installed in the module box. By using the module box, these heavy and bulky object components can be easily installed and removed, allowing easy repair and maintenance. Further, the components can be protected from damage during installation and detachment, and the user can use the image forming apparatus more conveniently.

### IMAGE FORMING APPARATUS

This application claims the benefit under 35 U.S.C. § 119(a) of Korean Patent Application No. 10-2004-0099769, filed on Dec. 1, 2004, in the Korean Intellectual Property Office, the entire disclosure of which is incorporated herein by reference.

### BACKGROUND OF THE INVENTION

1. Field of the Invention

The present invention relates to an image forming apparatus. More particularly, the present invention relates to an image forming apparatus having a module box in which components of the image forming apparatus can be easily installed and removed.

2. Description of the Related Art

An image forming process of an image forming apparatus includes the steps of charging a photoconductor to have a predetermined electrical potential, exposing the charged photoconductor to light to form an electrostatic latent image on a surface of the photoconductor by using a light scan unit such as a laser scan unit (LSU), developing the latent image into a visible toner image (a toner image) by applying a toner (developer) to the latent image on the photoconductor, feeding paper from a paper feeder along a feeding passage, transferring the toner image from the photoconductor to the fed paper, fusing the transferred toner image on the paper by applying heat and pressure, and outputting the fused paper.

Usually, heavy components, such as a development cartridge and a transfer belt assembly, are installed to and removed from the image forming apparatus in a vertical direction for stability during installation and detachment or other similar reasons.

The components of the image forming apparatus need to be removed and installed again for various reasons, including repair and maintenance. However, detachment and re-installation of the components is not easy because of the weight and volume of the components. Further, the components are potentially subject to damage during the removal and reinstallation procedures.

Accordingly, there is a need for an image forming apparatus with an improved structure for installing and removing components in the apparatus.

### SUMMARY OF THE INVENTION

An aspect of the present invention is to solve at least the above problems and/or disadvantages and to provide at least the advantages described below. Accordingly, an aspect of the present invention is to provide an image forming apparatus in which components of the image forming apparatus can be easily installed and removed.

According to an aspect of the present invention, an image forming apparatus includes a module box in which an object component is detachably installed. The module box moves between a first position at which the object component operates and a second position at which the object component is loaded and unloaded. A locking/unlocking unit locks the module box at the first position. A biasing unit that has one portion installed to the module box and another portion installed to the image forming apparatus biases the module box from the first position to the second position when the locking/unlocking unit is unlocked.

The biasing unit may be capable of fixing the biased module box to the second position.

The image forming apparatus further may include a guide portion installed at a main body of the image forming apparatus to guide the movement of the module box.

The locking/unlocking unit may include a toggle unit that toggles between a locked and an unlocked position when pressed from the second position to the first position.

The biasing unit may include a gas spring.

The biasing unit may include a shock absorber.

The toggle unit may include a fixed part and a moving part capable of coupling with the fixed part at the first position and moving together with the module box.

The biasing unit may include: a cylinder part installed at a main body of the image forming apparatus; and a piston part slidably inserted in the cylinder part, the piston part having an exposed portion installed at the module box to bias the module box from the first position to the second position.

The fixed part may be installed at the cylinder part, and the moving part may be installed at the piston part.

The fixed part may be installed at the cylinder part, and the moving part may be installed at the module box.

The fixed part may be installed at the main body of the image forming apparatus, and the moving part may be installed at the module box.

The fixed part may be installed at the main body of the image forming apparatus, and the moving part may be installed at the piston part.

The object component may be a development cartridge.

The object component may be an intermediate transfer belt (ITB) assembly.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a sectional view of an image forming apparatus according to an embodiment of the present invention;

FIG. 2 is a perspective view showing a module box placed at a first position according to an embodiment of the present invention;

FIG. 3 is a perspective view showing a module box placed at a second position according to an embodiment of the present invention;

FIG. 4 is a perspective view showing a locking/unlocking unit installed between a cylinder part and a piston part according to an embodiment of the present invention;

FIG. 5 is an enlarged perspective view of a locking/unlocking unit according to an embodiment of the present invention;

FIGS. 6 through 9 are views showing the operation of a locking/unlocking unit according to an embodiment of the present invention;

FIG. 10 is a view showing a locking/unlocking unit installed between a cylinder part and a module box according to an embodiment of the present invention;

FIG. 11 is a view showing a locking/unlocking unit installed between a main body of an image forming apparatus and a module box according to an embodiment of the present invention; and

FIG. 12 is a view showing a locking/unlocking unit installed between a main body of an image forming apparatus and a piston part according to an embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Further, in the following description, an electrographic image forming apparatus is used an examplary embodiment to describe the present invention, but the present invention can be applied to various images forming apparatuses and is not limited to the illustrated image forming apparatus.

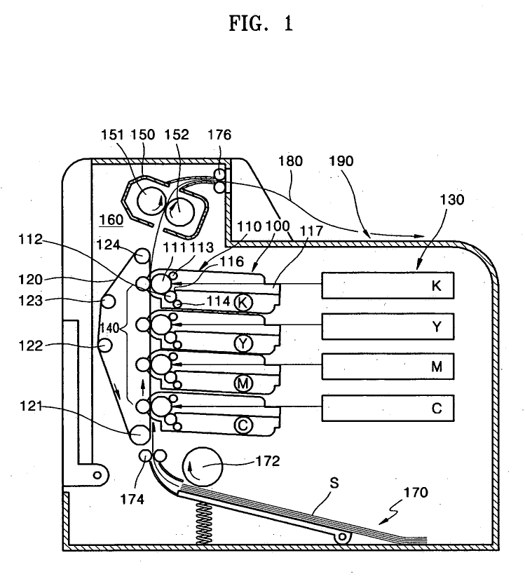

FIG. 1 is a sectional view of an image forming apparatus according to an embodiment of the present invention. Referring to FIG. 1, an electrophotographic image forming apparatus includes an image forming unit 160 for forming an image on paper S through an electrophotographic process, a cassette 170 for containing the paper S, a pick-up roller 172 for picking up the paper S from the cassette 170; and feed rollers 174 for conveying the paper S.

The image forming unit 160 includes a development assembly 110 with four development cartridges 110C, 110M, 110Y, and 110K, a transfer belt 120, four laser scanning units 130C, 130M, 130Y, and 130K, four transfer rollers 140, and a fuser 150.

The transfer belt 120 is rotatably supported by a plurality of supporting rollers 121, 122, 123, and 124. In this embodiment, the transfer belt 120 is installed in a vertical direction. The laser scanning units 130C, 130M, 130Y, and 130K apply lights to the photoconductive drums of the development cartridges 110C, 110M, 110Y, and 110K, respectively, in response to control signals. The light corresponds to cyan, magenta, yellow, and black image data, respectively.

Each of the development cartridges 110C, 110M, 110Y, and 110K includes a frame 100, a photoconductive drum 111, a development roller 112, a charge roller 113, a toner feed roller 114, a regulation member 116, a cleaning member, and a toner containing unit. The photoconductive drum 111 includes a metal drum and a photoconductive layer coating the metal drum. The photoconductive drum 111 is rotatably installed and a portion of its outer surface is exposed.

The charge roller 113 is applied with a charge bias voltage to uniformly charge the outer surface of the photoconductive drum 111. A corona discharger (not shown) can be used instead of the charge roller 113. The development roller 112, on which toner is attached, applies the toner to the photoconductive drum 111. In more detail, the development roller 112 takes up the toner in powder form and applies the toner to an electrostatic latent image formed on the photoconductive drum 111 to form a toner image. A development bias voltage is applied to the development roller 112 for the applying of the toner to the photoconductive drum 111.

The toner feed roller 114 supplies the toner to the development roller 112, and the regulation member 116 is mounted on the frame 100 to regulate the amount of the toner of the development roller 112.

Each of the development cartridges 110C, 110M, 110Y, and 110K may include an agitator (not shown) that supplies the toner toward the toner feed roller 114 and/or the development roller 112.

In the illustrated embodiment, the development cartridges 110C, 110M, 110Y, and 110K include openings 117 to allow light from the laser scanning units 130C, 130M, 130Y, and 130K to pass through toward the photoconductive drums 111. The exposed surface of the photoconductive drum 111 is faced with the transfer belt 120.

The transfer belt 120 is disposed between the transfer rollers 140 and the photoconductive drums 111, which are arranged to face one another. In this embodiment, the transfer rollers 140 have a transfer bias voltage with an opposite polarity to that of the toner images on the photoconductive drums 111, so that the toner images can be transferred to the paper (S). That is, electrostatic forces between the photoconductive drums 111 and the transfer rollers 140 enable the toner images to transfer to the paper (S).

The fuser 150 includes a heat roller 151 and a pressure roller 152 that are engaged to each other to apply heat and pressure to the toner image on the paper S when the paper S passes therethrough, such that the toner image can be securely adhered to the paper (S). The heat of the heat roller 151 melts the toner image and the pressure of the pressure roller 152 attaches the melted toner image to the paper S so that the toner image can be permanently attached on the paper S.

The eject rollers 176 discharges the paper S out of the image forming apparatus. The discharged paper S is stacked on an output tray 190 along a passage 180.

To remove/install heavy or bulky components (hereinafter, referred to as “object components”) such as the development cartridges 110C, 110M, 110Y, and 110K, the transfer belt (assembly) 120, and an intermediate transfer belt (ITB) assembly (not mentioned above but well known to those skilled in the art), the components are shifted in a predetermined direction from their operating positions and then removed/installed from/to the image forming apparatus in order to prevent damage of the object components or peripheral components. In the following description, the development cartridges 110C, 110M, 110Y, and 110K that have vertical installation and detachment features will be described as the object components according to an exemplary embodiment of the present invention. However, the present invention is not limited to the vertical installation and detachment features. The present invention can be applied to other object components that have horizontal or slanted installation and detachment directions.

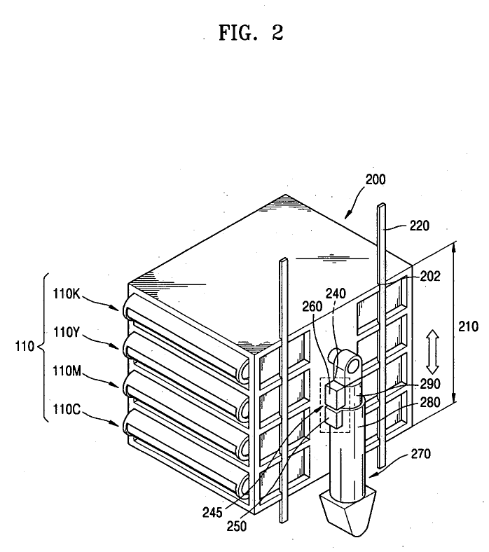

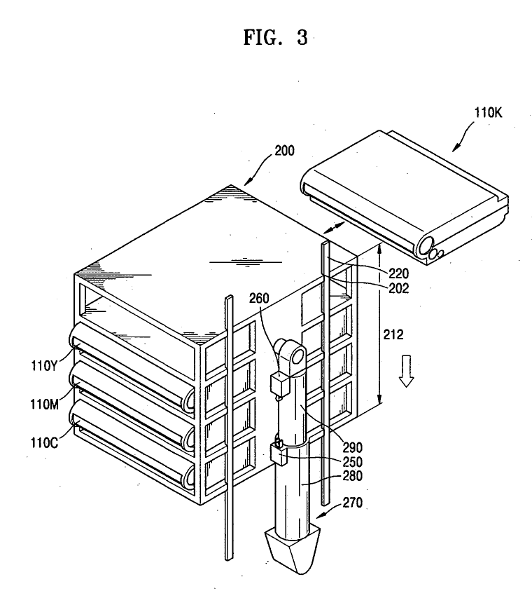

FIG. 2 is a perspective view showing a module box placed at a first position according to an embodiment of the present invention, and FIG. 3 is a perspective view showing a module box placed at a second position according to an embodiment of the present invention. Referring to FIGS. 2 and 3, the image forming apparatus includes a module box 200 for detachably loading the development cartridges 110C, 110M, 110Y, and 110K, a locking/unlocking unit 240 for locking/unlocking the module box 200, and a biasing unit 270 for biasing the module box 200 in a predetermined direction.

The module box 200 is provided to detachably load the development cartridges 110C, 110M, 110Y, and 110K (in other words, object components). The module box 200 is capable of moving between a first position 210 and a second position 212. The first position 210 is an operating position of the object component, and the second position 212 is an installing/removing position of the object component. Though the object component is loaded/unloaded to/from the module box 200 in this embodiment, the module box 200 can also be designed to be loaded/unloaded together with the object component. Further, though the module box 200 is shifted between the first position 210 and second position 212 in a vertical direction in this embodiment, the module box 200 can be shifted in a horizontal direction or in an inclined direction.

The biasing unit 270 includes a portion coupled to the module box 200 and another portion coupled to a main body of the image forming apparatus. The biasing unit 270 biases the module box 200 from the first position 210 to the second position 212 when the locking/unlocking unit 240 unlocks the module box 200.

The biasing unit 270 may include a cylinder part 280 fixed to the main body of the image forming apparatus and a piston part 290 fixed to the module box 200. The cylinder part 280 has a bore at its center for movement of the piston part 290. The piston part 290 is slidably inserted to the cylinder part 280, and the exposed end of the piston part is installed to the module box 200 to bias the module box 200 from the first position 210 to the second position 212. In more detail, a restoring force of the piston part 290 biases the module box 200 to the second position 212 when the locking/unlocking unit 240 is unlocked. An external force is required to move the module box 200 from the second position 212 to the first position 210 and lock the module box 200.

The biasing unit 270 may include a gas spring or a shock absorber. Since the gas spring and shock absorber are well known to those skilled in the art, a detailed description will be omitted.

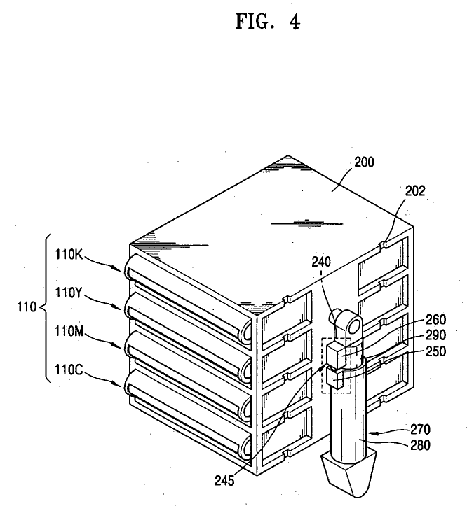

FIG. 4 is a perspective view showing the locking/unlocking unit installed between the cylinder part and the piston part according to an embodiment of the present invention. Referring to FIG. 4, the locking/unlocking unit 240 locks the module box 200 at the first position 210. When the locking/unlocking unit 240 unlocks the module box 200, the module box 200 is biased to the second position 212 by the biasing unit 270. The locking/unlocking unit 240 may include a toggle unit 245.

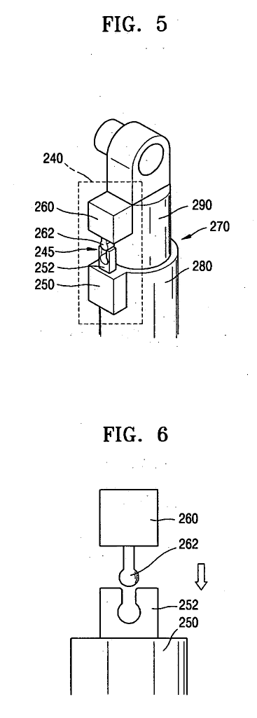

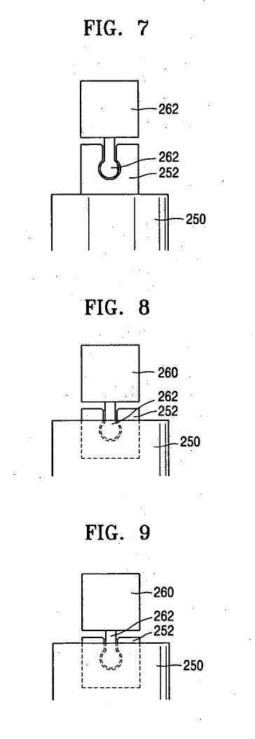

FIG. 5 is an enlarged perspective view of the locking/unlocking unit according to an embodiment of the present invention, and FIGS. 6 through 9 are views showing an operation of the locking/unlocking unit according to an embodiment of the present invention. Referring to FIG. 5, the toggle unit 245 is an on-off unit. Pushing the toggle unit 245 once in a downward direction makes it locked, and pushing it again in the same direction makes it unlocked. The toggle unit 245 includes a fixed part 250 and a moving part 260. The fixed part 250 is fixed to a predetermined position for coupling with the moving part 260. The fixed part 250 defines a coupling groove 252 at a predetermined position.

The moving part 260 moves together with the module box 200 and couples with the fixed part 250 at the first position 210. The moving part 260 includes a protrusion 262 at a predetermined portion. The protrusion 262 is inserted into the coupling groove 252 to fix the module box 200 at the first position 210. The coupling of the fixed part 250 and the moving part 260 is illustrated step by step in FIGS. 6 through 9. However, the present invention is not limited to the exemplary embodiment illustrated here. For example, the coupling groove 252 may be defined at the moving part 260, and the protrusion 262 may be formed at the fixed part 250.

Referring again to FIGS. 2 and 3, a guide portion 220 is slidably inserted in a guide rail 202. Though the guide portion 220 can be fixed to the biasing unit 270, the guide portion 220 may be preferably fixed to the main body of the image forming apparatus. The guide portion 220 guides the movement of the module box 200. That is, the guide portion 220 is slidably inserted in the guide rail 202 of the module box 200 to guide the module box 200.

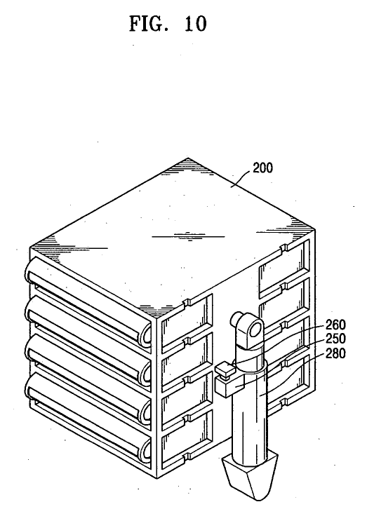

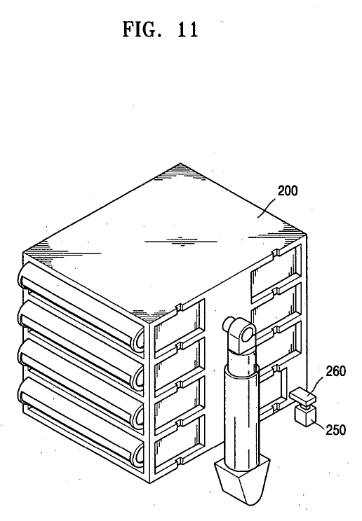

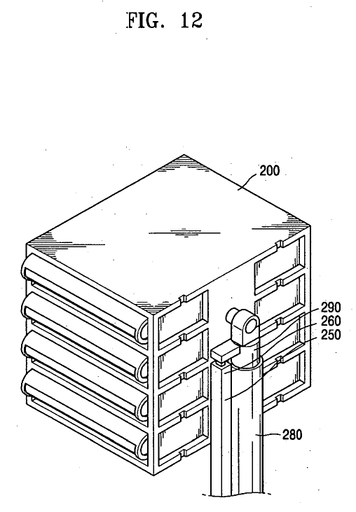

Referring again to FIG. 4, the fixed part 250 can be installed to the cylinder part 280, and the moving part 260 can be fixed to the piston part 290. Alternatively, the fixed part 250 can be installed to the cylinder part 280 and the moving part 260 can be fixed to the module box 200 (FIG. 10), the fixed part 250 can be installed to the main body of the image forming apparatus and the moving part 260 can be fixed to the module box 200. (FIG. 11), or the fixed part 250 can be installed to the main body of the image forming apparatus and the moving part 260 can be fixed to the piston part 290 (FIG. 12).

Although the development cartridges are used as an example in the description of this embodiment of the present invention, the present invention is not limited to use with the development cartridges. For example, the present invention is applicable to the transfer belt (assembly) 120 or the ITB assembly.

Hereinafter, the operation of the electrophotographic image forming apparatus will be described. The charge rollers 113, which have applied charge bias voltages, are used to charge the photoconductive drums 111 uniformly. The laser scanning units 130C, 130M, 130Y, and 130K produce light corresponding to cyan, magenta, yellow, and black image data, respectively. The light is applied to the charged photoconductive drums 111 through the openings 117, respectively. Each of the photoconductive drums 111 is selectively discharged by the applied light, such that charged portion and the discharged portion make a pattern (electrostatic latent image) on the drums.

Meanwhile, the toner feed roller 114 supplies toner to the development roller 112 where a development bias voltage is applied. The regulation member 116 regulates the toner on the development roller 112 to form a thin film layer of toner. The toner is charged by the friction between the development roller 112 and regulation member 116. The toner on the development roller 112 is transferred to the electrostatic latent image on the photoconductive drum 111. In this way, cyan, magenta, yellow, and black toner image can be formed on the photoconductive drums 111, respectively.

The pick-up roller 172 picks up the paper S from the cassette 170. The feed rollers 174 feed the paper S to the transfer belt 120. The paper S is attached to the transfer belt 120 by an electrostatic force so that the paper S can be conveyed by the transfer belt 120 without sliding. For example, when the leading end of the paper print area is conveyed to the nip point between the transfer roller 140 and the photoconductive drum 111 of the development cartridge 110C, the leading end of the cyan toner image on the photoconductive drum 111 is also conveyed to the nip point at the same time.

The cyan, magenta, yellow, and black toner images of the photoconductive drums 111 are sequentially transferred to the paper S when transfer bias voltage is applied to the transfer rollers 140. After this sequential transfer, a color image is formed on the paper S.

After the transferring, remaining toner on the photoconductive drums 111 is removed by the cleaning member 118. The fuser 150 applies heat and pressure to the toner image on the paper S to securely adhere the toner image to the paper. The paper S is discharged from the image forming apparatus by the eject rollers 176. The discharged paper S is stacked on the output tray 190.

As described above, somewhat heavy and bulky components (object components) can be easily installed to and removed from the image forming apparatus by using the biasing unit 270. This easy installation and detachment of the components also allows easy repair and maintenance. Further, the components can be protected from damage during installation and detachment, and users can use the image forming apparatus more conveniently.

While the invention has been shown and described with reference to certain embodiments thereof, it will be understood by those skilled in the art that various changes in form and details may be made therein without departing from the spirit and scope of the invention as defined by the appended claims.

What is claimed is:

1. An image forming apparatus comprising:
a module box in which an object component is detachably installed, the module box moving between a first position at which the object component can be operated and a second position at which the object component can be loaded and unloaded;
a locking/unlocking unit that locks the module box at the first position; and
a biasing unit having one portion installed to the module box and another portion installed to the image forming apparatus, the biasing unit biasing the module box from the first position to the second position when the locking/unlocking unit is unlocked.

2. The image forming apparatus of claim 1, wherein
the biasing unit fixes the module box to the second position by biasing the module box to the second position when the module box is unlocked.

3. The image forming apparatus of claim 2, further comprising
a guide portion installed at a main body of the image forming apparatus to guide the movement of the module box.

4. The image forming apparatus of claim 3, wherein
the locking/unlocking unit comprises a toggle unit that toggles between a locked state and an unlocked state when pressed from the second position to the first position in a direction parallel to the direction of movement of the module box.

5. The image forming apparatus of claim 4, wherein
the biasing unit comprises a gas spring.

6. The image forming apparatus of claim 4, wherein
the biasing unit comprises a shock absorber.

7. The image forming apparatus of claim 4, wherein
the object component is a development cartridge.

8. The image forming apparatus of claim 4, wherein
the object component is an ITB (intermediate transfer belt) assembly.

9. The image forming apparatus of claim 1, wherein
the locking/unlocking unit comprises a toggle unit that toggles between a locked state and an unlocked state when pressed from the second position to the first position in a direction parallel to the direction of movement of the module box.

10. The image forming apparatus of claim 9, wherein the toggle unit comprises:
a fixed part; and
a moving part that can be coupled or decoupled with the fixed part at the first position.

11. The image forming apparatus of claim 10, wherein the biasing unit comprises:
a cylinder part installed at a main body of the image forming apparatus; and
a piston part slidably inserted into the cylinder part, the piston part having a portion installed at the module box to bias the module box from the first position to the second position.

12. The image forming apparatus of claim 11, wherein the biasing unit comprises:
a gas spring.

13. The image forming apparatus of claim 11, wherein the biasing unit comprises:
a shock absorber.

14. The image forming apparatus of claim 11, wherein
the fixed part is installed at the cylinder part, and the moving part is installed at the piston part.

15. The image forming apparatus of claim 11, wherein
the fixed part is installed at the cylinder part, and the moving part is installed at the module box.

16. The image forming apparatus of claim 11, wherein
the fixed part is installed at the main body of the image forming apparatus, and the moving part is installed at the module box.

17. The image forming apparatus of claim 11, wherein
the fixed part is installed at the main body of the image forming apparatus, and the moving part is installed at the piston part.

18. The image forming apparatus of claim 11, wherein
the object component is a development cartridge.

19. The image forming apparatus of claim 11, wherein
the object component is an intermediate transfer belt (ITB) assembly.

20. The image forming apparatus of claim 11, wherein
the object component is a transfer belt assembly.
